(19) United States
(12) Patent Application Publication
(10) Pub. No.: US 2013/0117324 A1
(43) Pub. Date: May 9, 2013

(54) Systems and Methods for Providing Electronic Help

(71) Applicants: Hans-Jurgen Greiner, Desert Hills, AZ (US); James Jerome Smart-Foster, Scottsdale, AZ (US)

(72) Inventors: Hans-Jurgen Greiner, Desert Hills, AZ (US); James Jerome Smart-Foster, Scottsdale, AZ (US)

(73) Assignee: American Express Travel Related Services Company, Inc., New York, NY (US)

(21) Appl. No.: 13/290,241

(22) Filed: Nov. 7, 2011

(51) Int. Cl. G06F 17/30

(52) U.S. Cl. 707/793; 707/E17.048

(57) ABSTRACT

A system, method, and article of manufacture for providing electronic help is disclosed. The method may comprise receiving a search query, searching, by a search library and in response to the search query, a document object model (“DOM”) structure associated with a webpage, and identifying a portion of the webpage based upon the searching. In various embodiments, the method may further comprise receiving a selection of an option to receive electronic help, communicating with a help database to retrieve help data, and displaying a storyboard associated with the help data. The storyboard may be displayed in a pertinent portion of a webpage based upon the DOM structure of the webpage. The help data may be further received based upon the search query.

### BACKGROUND

1. Field

The present disclosure generally relates to electronic help. More particularly, the present disclosure relates to improved systems and methods for providing interactive electronic help.

2. Related Art

Traditionally, online or web-based help has been provided as a single, hard-coded, application or set of application files, which may be tailored to a particular web-page or software application. A user may search for help related to a particular subject, and this action may invoke a separate, stand-alone, help utility based upon the hard-coded application files. In some instances, help may be provided more dynamically. For example, help may be provided as a tip which appears over a particular element when a user rolls or moves his or her mouse or cursor over the element (“rollover”).

Accordingly, a system and method for searching within a web-page (as opposed to through or within a help file) is desirable. Further, a system and method for providing information, help, and/or assistance based upon a request by a user for such help is desirable (as opposed to in response to a rollover event, which may disrupt a user's browsing journey or experience).

### SUMMARY

The present disclosure includes a system, method, and article of manufacture for providing electronic help. The method may comprise receiving a search query, searching (by a search library and in response to the search query) a document object model (“DOM”) structure associated with a webpage, and identifying a portion of the webpage based upon the searching. In various embodiments, the method may further comprise receiving a selection of an option to receive electronic help, communicating with a help database to retrieve help data, and displaying a storyboard associated with the help data. The storyboard may be displayed in a pertinent portion of a webpage based upon the DOM structure of the webpage. The help data may be further received based upon the search query. In various embodiments, the method may further comprise communicating with a help database to install and/or run the search library in response to a request for help, shifting focus to the pertinent portion of the webpage, and/or receiving feedback.

### BRIEF DESCRIPTION OF THE DRAWINGS

The features and advantages of the present disclosure will become more apparent from the detailed description set forth below when taken in conjunction with the drawings. The left-most digit of a reference number identifies the drawing in which the reference number first appears.

FIG. 1 shows an exemplary system diagram in accordance with various embodiments.

FIG. 2 shows a flowchart depicting an exemplary process for providing electronic help based upon a search query.

FIG. 3A shows a screenshot depicting an exemplary webpage for providing electronic help based upon a search query.

FIG. 3B shows a screenshot depicting an exemplary webpage for providing electronic help based upon a search query.

FIG. 4 shows a flowchart depicting an exemplary process for providing electronic help based upon a request for help.

FIG. 5A shows a screenshot depicting an exemplary webpage for providing electronic help based upon a request for help.

FIG. 5B shows a screenshot depicting an exemplary webpage for providing electronic help based upon a request for help.

FIG. 6 shows a screenshot depicting an exemplary webpage for collecting feedback.

FIG. 7A shows a screenshot depicting an exemplary webpage for providing electronic help to a transaction account holder.

FIG. 7B shows a screenshot depicting an exemplary webpage for providing electronic help to a transaction account holder.

### DETAILED DESCRIPTION

A system for providing electronic help is disclosed. More particularly, in various embodiments, a system for providing interactive electronic help is disclosed. In various embodiments, the system may provide interactive online and/or web-based help, in which a user may search through the DOM structure associated with a web-page and/or in which an individual may receive help in response to a request for help.

The detailed description of exemplary embodiments herein makes reference to the accompanying drawings, which show the exemplary embodiments by way of illustration and their best mode. While these exemplary embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

As used herein, “transmit” and/or “communicate” may include sending electronic data from one system component to another over a network connection. Additionally, as used herein, “data” may include encompassing information such as commands, queries, files, data for storage, and the like in digital or any other form.

Phrases and terms similar to “account,” “transaction account,” “account,” “account number,” “account code,” and/or “consumer account” may include any account that may be used to facilitate a financial transaction. These accounts may include any device, code (e.g., one or more of an authorization/access code, personal identification number (“PIN”), Internet code, other identification code, and/or the like), number, letter, symbol, digital certificate, smart chip, digital signal, analog signal, biometric or other identifier/indicia suitably configured to allow the consumer to access, interact with or communicate with the system. The account number may optionally be located on or associated with a rewards account, charge account, credit account, debit account, prepaid account, telephone card, embossed card, smart card, magnetic stripe card, bar code card, transponder, radio frequency card or an associated account.

As used herein, a “user” may comprise any individual, group, entity, organization machine, hardware, software, business, and/or combination of these. For instance, a “user” may comprise any individual who interfaces with a system for providing electronic help (e.g., system 100). A bank may be part of the system, but the bank may represent other types of card issuing institutions, such as credit card companies, card sponsoring companies, or third party issuers under contract with financial institutions. It is further noted that other participants may be involved in some phases of the transaction, such as an intermediary settlement institution, but these participants are not shown.

As used herein, a “web-page” and/or “webpage” may comprise any file and/or group of files that may be read and/or rendered by a web browser. Thus, a web-page may include a web-page this is available online, via the Internet, as well as a web-page that is rendered by a web browser in an offline environment. Moreover, the term “webpage,” as it is used herein, is not meant to limit the type of documents and applications that might be used to interact with the user. For example, a typical website might include webpages comprising, in addition to standard HTML documents, various forms, Java® applets, JavaScript®, active server pages (ASP), common gateway interface scripts (CGI), extensible markup language (XML), dynamic HTML, cascading style sheets (CSS), document object model (“DOM”) data, AJAX (Asynchronous Javascript® And XML), helper applications, plug-ins, JavaScript® applications and/or software libraries, and the like.

As used herein, a “web browser” or “browser” may comprise software and/or hardware for browsing and/or displaying a webpage. Thus, in various embodiments, a browser may comprise software such as, for example, Mozilla Firefox®, Microsoft Internet Explorer®, Apple Safari®, Google Chrome®, and the like.

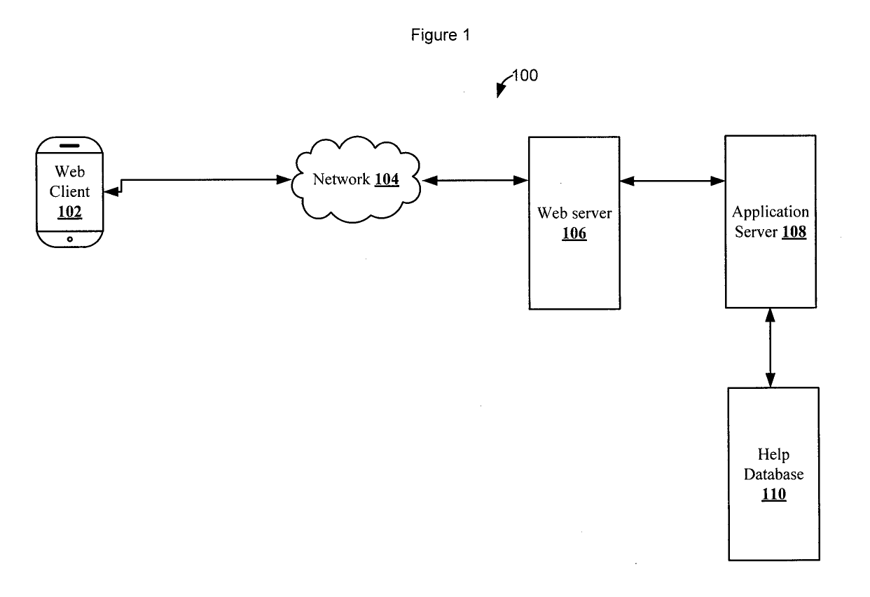

Referring to FIG. 1, an exemplary system 100 for providing electronic help is disclosed. In various embodiments, system 100 may comprise a web client 102, a network 104, a web server 106, an application server 108, and/or a help database 110.

A web client 102 may include any device (e.g., personal computer) which communicates via any network, for example such as those discussed herein. A web client 102 may include one or more browses or browser applications and/or application programs, including browser applications comprising Internet browsing software installed within a computing unit or a system to conduct online transactions and/or communications. For example, in various embodiments, a web client 102 may include (and run) Microsoft Internet Explorer, Mozilla Firefox, Google Chrome, Apple Safari, and/or any of the other myriad software packages available for browsing the Internet.

A computing unit or system may take the form of a computer or set of computers, although other types of computing units or systems may be used, including tablets, laptops, notebooks, hand held computers, personal digital assistants, cellular phones, smart phones, set-top boxes, workstations, computer-servers, main frame computers, mini-computers, PC servers, pervasive computers, network sets of computers, personal computers, such as iPads, iMACs, and MacBooks, kiosks, terminals, point of sale (POS) devices and/or terminals, televisions, or any other device capable of receiving data over a network. The computing unit of the web client 102 may be further equipped with an Internet browser connected to the Internet or an intranet using standard dial-up, cable, DSL or any other Internet protocol known in the art. Transactions originating at a web client 102 may pass through a firewall in order to prevent unauthorized access from users of other networks. Further, additional firewalls may be deployed between the varying components of system 100 to further enhance security.

A web client 102 may or may not be in direct contact with an application server. For example, a web client 102 may access the services of an application server through another server and/or hardware component, which may have a direct or indirect connection to an Internet server. For example, a web client 102 may communicate with an application server via a load balancer. In an exemplary embodiment, access is through a network or the Internet through a commercially-available web-browser software package.

A web client 102 may further include an operating system (e.g., Windows NT, 95/98/2000/CE/Mobile, OS2, UNIX, Linux, Solaris, MacOS, PalmOS, etc.) as well as various conventional support software and drivers typically associated with computers. A web client 102 may be in a home or business environment with access to a network. A web client 102 may implement security protocols such as Secure Sockets Layer (SSL) and Transport Layer Security (TLS). A web client 102 may further implement several application layer protocols including http, https, ftp, and sftp.

A network 104 may include any electronic communications system or method which incorporates hardware and/or software components (e.g. a “cloud” or “cloud computing” system, as described herein). Communication among parties via a network 104 may be accomplished through any suitable communication channels, such as, for example, a telephone network, an extranet, an intranet, Internet, point of interaction device (point of sale device, personal digital assistant (e.g., iPhone®, Palm Pilot®, Blackberry®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system 100 is frequently described herein as being implemented with TCP/IP communications protocols, the system may also be implemented using IPX, Appletalk, IP-6, NetBIOS, OSI, any tunneling protocol (e.g. IPsec, SSH), or any number of existing or future protocols. If the network 104 is in the nature of a public network, such as the Internet, it may be advantageous to presume the network 104 to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

The various system components may be independently, separately or collectively suitably coupled to the network 104 via data links which include, for example, a connection to an Internet Service Provider (ISP) over the local loop as is typically used in connection with standard modem communication, cable modem, Dish networks, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that network 104 may be implemented variously, such as, for example, as an interactive television (ITV) network. Moreover, this disclosure contemplates the use, sale or distribution of any goods, services or information over any network having similar functionality described herein.

“Cloud” or “Cloud computing” may comprise a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing at http://csrc.nist.gov/groups/SNS/cloud-computing/cloud-def-v15.doc (last visited Feb. 4, 2011), which is hereby incorporated by reference in its entirety.

Web-server 106 may comprise hardware and/or software configured to serve static and/or dynamic content, directly or via network 104, to web-client 102. Web-server 106 may further communicate, directly or via network 104, with one or more application servers 108 and/or one or more help databases 110.

Application server 108 may comprise hardware and/or software configured to serve static and/or dynamic content, directly or via network 104, to web-server 106 and/or web-client 102. Application server 108 may further communicate, directly or via network 104, with one or more web-servers 106 and/or one or more help databases 110.

Help database 110 may comprise hardware and/or software configured to host a database. For example, help database 110 may comprise a server appliance running a suitable server operating system (e.g., Microsoft Internet Information Services® or, “IIS”) and having database software (e.g., Oracle) installed thereon. In various embodiments, help database 110 may comprise data represented in a JavaScript® Object Notation (“JSON”) format.

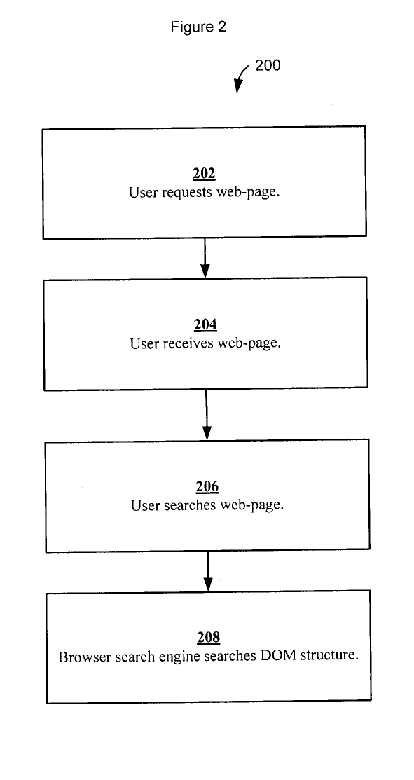

Referring now to FIGS. 2-7B the process flows and screenshots depicted are merely embodiments and are not intended to limit the scope of the disclosure. For example, the steps recited in any of the method or process descriptions may be executed in any order and are not limited to the order presented. It will be appreciated that the following description makes appropriate references not only to the steps and user interface elements depicted in FIGS. 2-7, but also to the various system components as described above with reference to FIG. 1.

With certain reference now to FIG. 2, a process 200 for providing electronic help is disclosed. In various embodiments, a user may request a webpage (step 202) and/or receive a webpage (step 204). For instance, a user may receive (by way of a browser running on his web client 102) a webpage, and this may occur in response to a request, by the browser running on the web client 102, for the webpage. A user may further, in various embodiments, search a webpage (206), and in response, a user's browser (again, running on the user's web client 102) may search through or within the DOM structure associated with the user's webpage (step 208).

More particularly, and in various embodiments, a user's browser may include one or more software libraries (e.g., one or more JavaScript® libraries), which may include a variety of components (e.g., functions, objects, and the like) for searching the DOM structure of a webpage. These software libraries may run on and/or be preinstalled as part of a user's browser and/or installed later, e.g., during an update and/or in response to a request by the browser for a webpage and/or a request for help. As used herein, software libraries of this type may, for simplicity, and collectively and/or individually, be referred to as a “search library.”

Thus, in various embodiments, a user may run a search query using a search GUI, e.g., a field or search box and/or a search button. In response to receiving a search query, a user's browser may run one or more of the components comprising a search library, which may, in turn, search for the user's query term (e.g., the text entered by the user in the search box) within the DOM structure of the webpage loaded in the user's browser.

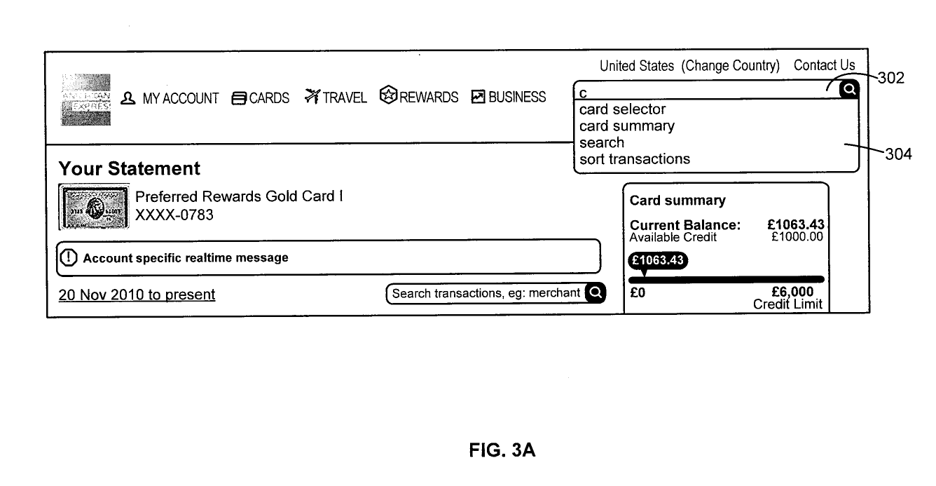

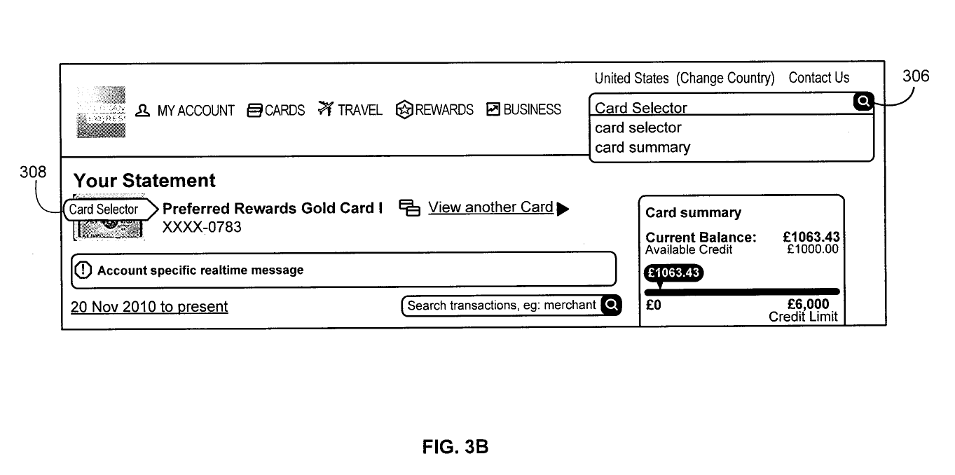

For example, and with reference to FIG. 3A, a user may insert or enter a query in a search box 302. In response to entry of a query term and/or terms, a search library installed on and/or running as part of the user's browser may search the DOM structure (including all of the data comprising and/or representing the DOM structure) of the webpage currently displayed by the browser. More particularly, and in various embodiments, a search library may comprise one or more components configured to receive and/or parse the search query and, in response, to search the DOM structure of the webpage loaded in the browser. A search library may be further configured to display a predictive list 304, which may change as the user continues to enter a query. For instance, where a user enters a partial search term (e.g., the letter “c”), a function, object, and/or the like comprising a search library may dynamically search through the DOM structure of the webpage loaded in the user's browser to display partial matches (e.g., “card selector,” “card summary,” “search,” “sort transactions,” etc.)

With reference now to FIG. 3B, a user may finalize a query and/or select an option 306 to perform a search for the query term(s). In response, the search library installed and/or running on the user's browser may search through the DOM structure for the requested term or terms (and/or the nearest and/or most similar term or terms). One or more components comprising the search library may, in various embodiments, generate and/or display and/or render a pointer or identifier 308 to one or more areas of a webpage based upon an entered and/or requested search term or terms.

More particularly, and in various embodiments, a component comprising a search library may display or cause to be displayed in a browser and on the webpage being searched, a pointer 308 to one or more portions of the webpage that correspond to the search query. Further, and in various embodiments, the search library may comprise a component that is configured to shift focus to the portion(s) of a webpage corresponding to a search query. For example, the search library may, in response to entry of a search query, cause the browser to move the portion of the webpage corresponding to the search query and/or the pointer 308 displayed in association with the portion to a part or region of the browser display (e.g., a central or center portion). Further, in various embodiments, the search library may, again, in response to entry of a search query, cause the browser to transfer focus to the portion of the webpage that corresponds to the search query (e.g., to make the portion of the webpage corresponding to the search query active).

Thus, in various embodiments, a search library may permit a user to search within the DOM structure of a webpage. This feature may, in various embodiments, comprise a significant advantage over many prior art search utilities, which require that a browser load, in response to a search query, a static, hard coded, search file. In contrast, the search library (as discussed herein) may be installed with and/or run on any browser and run against any webpage, even if the webpage is not associated with a static, hard coded help file. Indeed, the disclosed search library may permit any DOM based webpage to be searched. Further, because the disclosed search library is configured to search through the DOM structure of a webpage, the search is always up to date with the content of the webpage (because it is based upon the content in the webpage). That is, and in other words, a user may use the search library to perform a search, and the search will not be obsolete or outdated as it might be, for example, in a prior art system utilizing a static, hard coded, help file (which would need to be updated to keep pace with updates to the webpage).

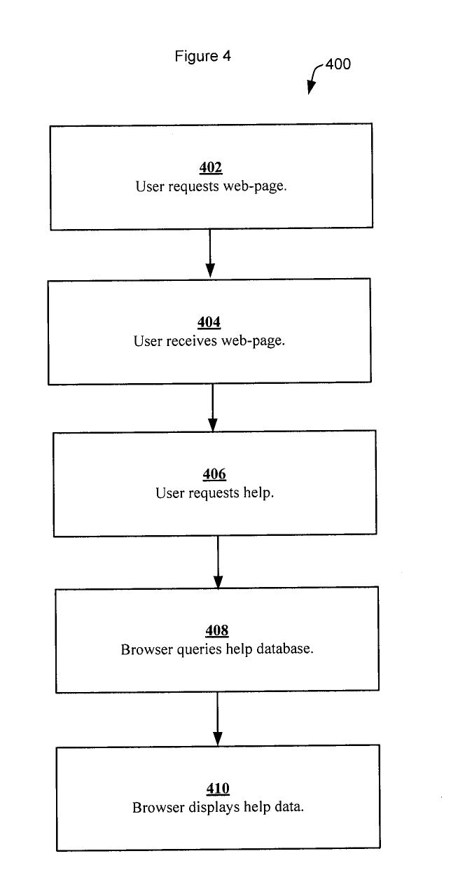

With reference to FIG. 4, a process 400 for providing electronic help is disclosed. In various embodiments, process 400 may comprise a standalone process and/or process 400 may be implemented by a browser, as described herein, and in conjunction with process 200. Thus, in various embodiments, a user may request a webpage (step 402) and/or receive a webpage (step 404). For instance, a user may receive (by way of a browser running on his web client 102) a webpage, and this may occur in response to a request, by the browser running on the web client 102, for the webpage. A user may further, in various embodiments, request help (step 406). In response to a request for help, a user's browser may query a help database (408) and/or display help data (step 410).

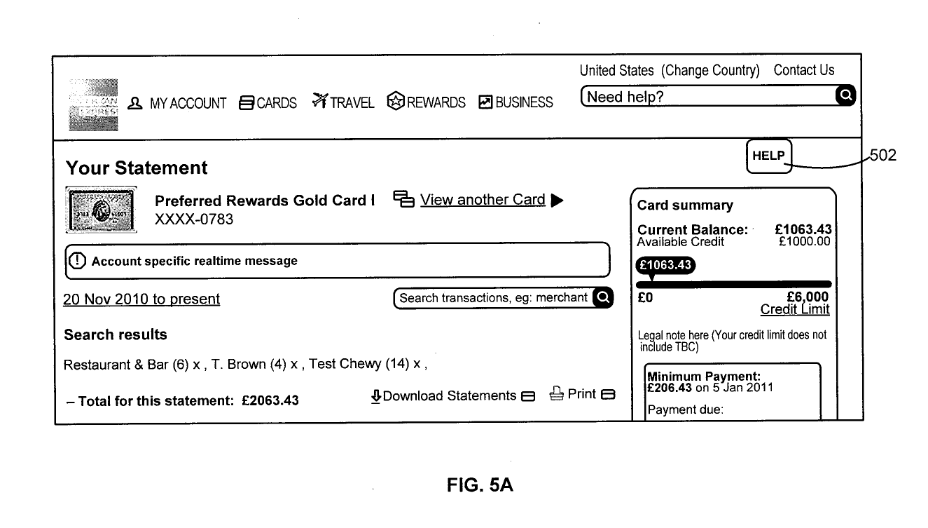

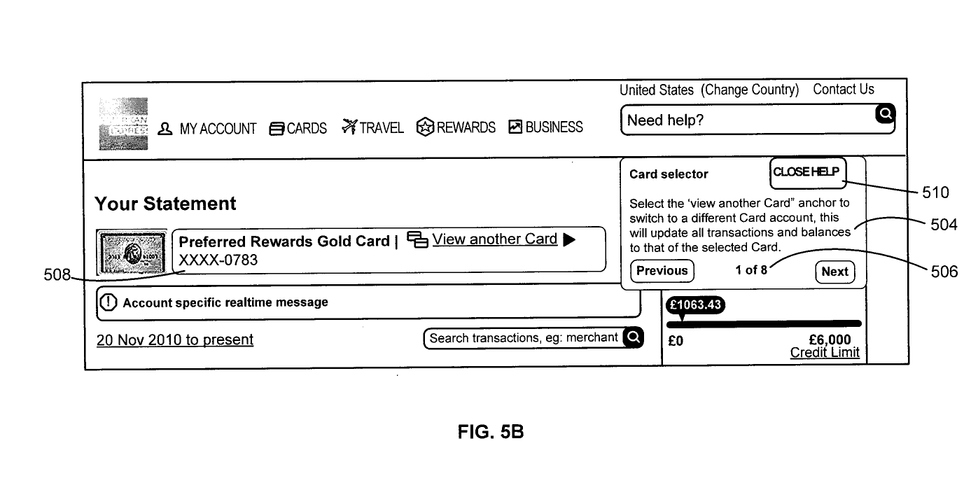

More particularly, and with reference to FIG. 5A, a user may select a help option 502, which may invoke, as described herein, a search library (e.g., a JavaScript® software library). More particularly, selection of help option 502 may invoke a component comprising part of a search library. In various embodiments, the search library may, in response to selection of help option 502, communicate with help database 110 (e.g., over network 104 and via web client 102, web server 106 and/or application server 108). More particularly, and in various embodiments, database 108 may, in response to a request by a component of a search library, locate and/or communicate data corresponding to a webpage loaded by a user's browser. For example, database 110 may communicate data about one or more portions of a webpage and/or data about or related to the DOM structure associated with the webpage. In various embodiments, portions of a webpage may relate to, for example, a card summary, a card selector, a sort transactions option, an amount heading, a cardmember heading, a category heading, a description heading, a date heading, an add or remove columns option, and the like.

In various embodiments, and with attention to FIG. 5B, a user may select a help option 502, which may, by way of a search library component, request from database 110 a variety of help data. As described herein, help data may reside on database 110 in a JSON format. Moreover, data may be communicated from database 110 to a user's browser in a JSON format. Thus, a browser may receive a variety of help data, and the search library associated with the browser (e.g., one or more components of the search library) may interpret and display this data 504 for a user's benefit. In various embodiments, help data 504 may be displayed for a user in any portion of a browser display and in any format and/or in any structure that is convenient. For example, help data 504 may be displayed as a series of slides or tips, and/or as a storyboard 506. Moreover, in various embodiments, help data 504 may be retrieved from database 110 in response to a search query, as described herein, in which case, help data 504 may be related to the subject of the search query.

In various embodiments, as a browser displays help data 504, one or more components of the search library (as described herein) may activate and/or highlight and/or point to and/or identify a related or corresponding portion of the webpage and/or the help data 504. For instance, in various embodiments, one or more components of a search library may cause a portion of a webpage 508 to glow and/or the components may highlight or otherwise indicate the relevance of a portion of a webpage 508 related to a search query and/or related to help data 504 that is currently displayed. This may be accomplished (as described herein) by adjusting, via one or more components of the search library, a part of, or data within, the DOM structure of the webpage. For example, a component of the search library may search the DOM structure of a webpage in response to or based upon a search query and/or help data 504, and, locating a relevant and/or corresponding data element in the DOM structure, modify the DOM structure such that the data element is activated. A user may further select an option to close help 510, which, if selected, may cause the search library to remove help data 504 from a webpage and/or to deactivate or de-identify any activated or identified (e.g., glowing or highlighted) portions of a webpage.

In various embodiments, a search library may interact with a webpage. For example, a help library may (e.g., where a user selects a help option 502) load and/or input a sample, or dummy, search in a search box 302. Thus, a help library may issue commands to a webpage to demonstrate, for a user, how a variety of help options may be used and/or used most effectively.

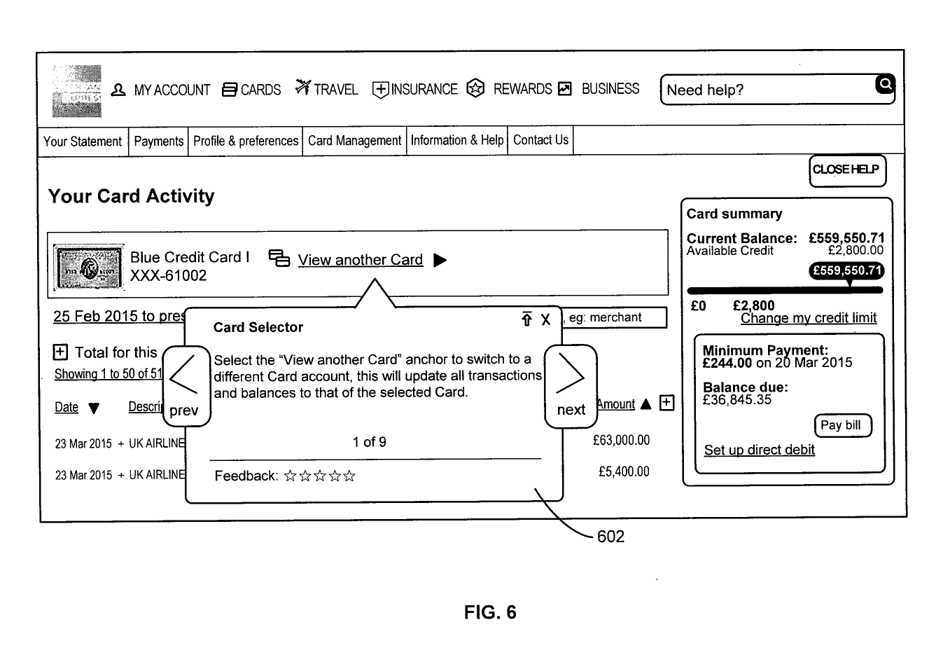

Referring to FIG. 6, in various embodiments, a search library may permit a user to give feedback 602. Feedback 602 may be provided in a variety of forms, including as a number of stars and/or on a discrete scale (e.g., a scale of 1 to 5, 1 to 10, and the like). Feedback 602 may be collected by a component of the search library, as described herein, and communicated to another part of system 100 (e.g., help database 110) and/or to another system coupled to network 104. Feedback 602 may be further collected for each slide or tip comprising a storyboard, as described herein, and/or for a search query box, and/or for a storyboard as a whole.

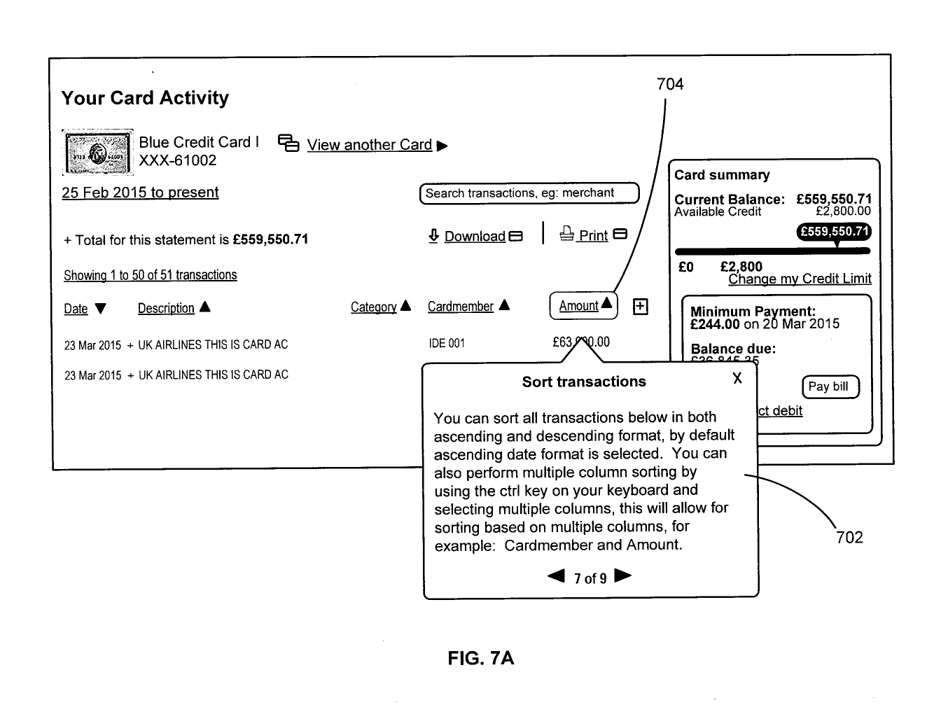

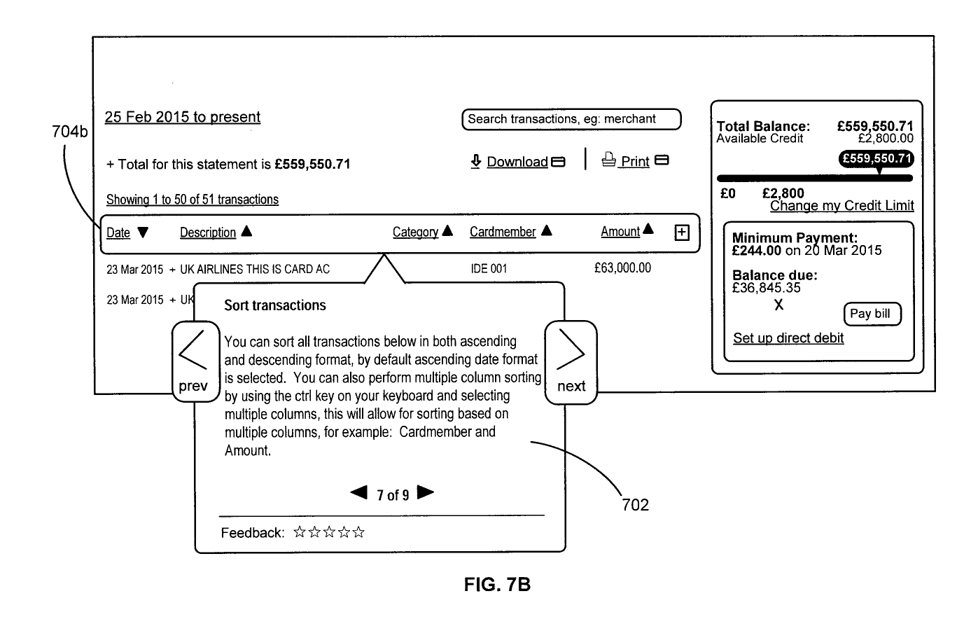

With attention to FIGS. 7A and 7B, a webpage for providing electronic help to a transaction account holder is disclosed. As shown in FIG. 7A, a search library may provide help data (e.g., a storyboard tip or help 702), as described herein, in a pertinent portion 704a of a webpage. For example, each storyboard tip may be related to a portion of a webpage (or one or more elements within the DOM structure), and as a user navigates through each storyboard tip 702, a search library may locate the DOM element to which the tip 702 corresponds and render or display the tip 702 in association with that element. As described herein, a search library may, in addition, transfer or shift the focus from one element or portion of a webpage to the next as a user navigates through a series of storyboard tips 702. Likewise, and as described herein, a search library may also interact with the DOM element to which the tip 702 corresponds (e.g., the search library may load and/or input a dummy search as a demonstration).

Thus, as shown in FIGS. 7A and 7B, a storyboard tip 702 may be displayed in association with a pertinent portion 704a and/or a pertinent portion 704b, depending upon the nature of the DOM structure. For example, in various embodiments, any or all of the fields in portion 704b may be associated, in the DOM structure, with a “sort transactions” tag or label. Likewise, in various embodiments, the portion 704a may individually be associated with a “sort transactions” tag or label in the DOM structure. Thus, although a variety of portions of a DOM structure may be associated with a variety of tags or labels, each of these may be used, in various embodiments, to associate a storyboard tip 704a and/or 704b and/or other help data with the portion of the webpage that is tied, through the DOM, to these tags or labels.

Accordingly, in various embodiments, a search library as disclosed herein may permit a user to control the manner and timing in which he receives help data and/or a storyboard, as opposed, for example, to providing unwanted and/or potentially frustrating and/or cumbersome “rollover” help, as described above. Indeed, the disclosed search library may provide a more user friendly and streamlined format for the provision and delivery of electronic help. As described herein, the disclosed search library may further provide electronic help in response to a search query by a user, which may, in various embodiments, comprise a pointer and/or identifier and/or an activated or highlighted portion of a webpage displayed individually and/or in conjunction with help data and/or a storyboard. In this regard, a search library may, as described herein, search based upon the DOM structure of a webpage, which may permit the search library to be used with any webpage. This feature may, in addition, represent an increase in the speed of a query based search, since it is not, in various embodiments, necessary to communicate with a server or over a network to search the DOM structure of a webpage loaded in the browser of a web client 102.

Systems, methods and computer program products are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. After reading the description, it will be apparent to one skilled in the relevant art(s) how to implement the disclosure in alternative embodiments.

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., Windows NT, Windows 95/98/2000, Windows XP, Windows Vista, Windows 7, OS2, UNIX, Linux, Solaris, MacOS, etc.) as well as various conventional support software and drivers typically associated with computers. A user may include any individual, business, entity, government organization, software and/or hardware that interact with a system.

In various embodiments, various components, modules, and/or engines of system 100 may be implemented as micro-applications or micro-apps. Micro-apps are typically deployed in the context of a mobile operating system, including for example, a Palm mobile operating system, a Windows mobile operating system, an Android Operating System, Apple iOS, a Blackberry operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

The system contemplates uses in association with web services, utility computing, pervasive and individualized computing, security and identity solutions, autonomic computing, cloud computing, commodity computing, mobility and wireless solutions, open source, biometrics, grid computing and/or mesh computing.

Any databases discussed herein may include relational, hierarchical, graphical, or object-oriented structure and/or any other database configurations. Common database products that may be used to implement the databases include DB2 by IBM (Armonk, N.Y.), various database products available from Oracle Corporation (Redwood Shores, Calif.), Microsoft Access or Microsoft SQL Server by Microsoft Corporation (Redmond, Wash.), MySQL by MySQL AB (Uppsala, Sweden), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In one exemplary embodiment, the ability to store a wide variety of information in different formats is facilitated by storing the information as a BLOB. Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with the financial transaction instrument by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments, the data can be stored without regard to a common format. However, in one exemplary embodiment, the data set (e.g., BLOB) may be annotated in a standard manner when provided for manipulating the data onto the financial transaction instrument. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a stand alone interaction device configured to add, delete, modify, or augment the data in accordance with the header or trailer. As such, in one embodiment, the header or trailer is not stored on the transaction device along with the associated issuer-owned data but instead the appropriate action may be taken by providing to the transaction instrument user at the stand alone device, the appropriate option for the action to be taken. The system may contemplate a data storage arrangement wherein the header or trailer, or header or trailer history, of the data is stored on the transaction instrument in relation to the appropriate data.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

Encryption may be performed by way of any of the techniques now available in the art or which may become available—e.g., Twofish, RSA, El Gamal, Schorr signature, DSA, PGP, PKI, and/or symmetric and asymmetric cryptosystems.

A firewall may include any hardware and/or software suitably configured to protect CMS components and/or enterprise computing resources from users of other networks. Further, a firewall may be configured to limit or restrict access to various systems and components behind the firewall for web clients connecting through a web server. Firewall may reside in varying configurations including Stateful Inspection, Proxy based, access control lists, and Packet Filtering among others. Firewall may be integrated within an web server or any other CMS components or may further reside as a separate entity. A firewall may implement network address translation (“NAT”) and/or network address port translation (“NAPT”). A firewall may accommodate various tunneling protocols to facilitate secure communications, such as those used in virtual private networking. A firewall may implement a demilitarized zone (“DMZ”) to facilitate communications with a public network such as the Internet. A firewall may be integrated as software within an Internet server, any other application server components or may reside within another computing device or may take the form of a standalone hardware component.

The computers discussed herein may provide a suitable website or other Internet-based graphical user interface which is accessible by users. In various embodiments, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, Interbase, etc., may be used to provide an Active Data Object (ADO) compliant database management system. In various embodiments, the Apache web server is used in conjunction with a Linux operating system, a MySQL database, and the Perl, PHP, and/or Python programming languages.

Any of the communications, inputs, storage, databases or displays discussed herein may be facilitated through a website having web pages. A server may include a web service that receives a request from a web server, the request including a URL (http://yahoo.com/stockquotes/ge) and an IP address (123.56.789.234). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. See, e.g., ALEX NGHIEM, IT WEB SERVICES: A ROADMAP FOR THE ENTERPRISE (2003), hereby incorporated by reference.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the Internet server. Middleware may be configured to process transactions between the various components of an application server and any number of internal or external systems for any of the purposes disclosed herein. WebSphere MQ™ (formerly MQSeries) by IBM, Inc. (Armonk, N.Y.) is an example of a commercially available middleware product. An Enterprise Service Bus (“ESB”) application is another example of middleware.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, Java, JavaScript, VBScript, Macromedia Cold Fusion, COBOL, Microsoft Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

Each participant is equipped with a computing device in order to interact with the system and facilitate online commerce transactions. The customer has a computing unit in the form of a personal computer, although other types of computing units may be used including laptops, notebooks, hand held computers, set-top boxes, cellular telephones, touch-tone telephones and the like. The merchant has a computing unit implemented in the form of a computer-server, although other implementations are contemplated by the system. The bank has a computing center shown as a main frame computer. However, the bank computing center may be implemented in other forms, such as a mini-computer, a PC server, a network of computers located in the same of different geographic locations, or the like. Moreover, the system contemplates the use, sale or distribution of any goods, services or information over any network having similar functionality described herein

The merchant computer and the bank computer may be interconnected via a second network, referred to as a payment network. The payment network which may be part of certain transactions represents existing proprietary networks that presently accommodate transactions for credit cards, debit cards, and other types of financial/banking cards. The payment network is a closed network that is assumed to be secure from eavesdroppers. Exemplary transaction networks may include the American Express®, VisaNet® and the Veriphone® networks.

The electronic commerce system may be implemented at the customer and issuing bank. In an exemplary implementation, the electronic commerce system is implemented as computer software modules loaded onto the customer computer and the banking computing center. The merchant computer does not require any additional software to participate in the online commerce transactions supported by the online commerce system.

As will be appreciated by one of ordinary skill in the art, the system may be embodied as a customization of an existing system, an add-on product, upgraded software, a stand alone system, a distributed system, a method, a data processing system, a device for data processing, and/or a computer program product. Accordingly, the system may take the form of an entirely software embodiment, an entirely hardware embodiment, or an embodiment combining aspects of both software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

Computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, webpages, websites, web forms, prompts, etc. Practitioners will appreciate that the illustrated steps described herein may comprise in any number of configurations including the use of windows, webpages, web forms, popup windows, prompts and the like. It should be further appreciated that the multiple steps as illustrated and described may be combined into single webpages and/or windows but have been expanded for the sake of simplicity. In other cases, steps illustrated and described as single process steps may be separated into multiple webpages and/or windows but have been combined for simplicity.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

In various embodiments, a transponder, transponder-reader, and/or transponder-reader system are configured with a biometric security system that may be used for providing biometrics as a secondary form of identification. The biometric security system may include a transponder and a reader communicating with the system. The biometric security system also may include a biometric sensor that detects biometric samples and a device for verifying biometric samples. The biometric security system may be configured with one or more biometric scanners, processors and/or systems. A biometric system may include one or more technologies, or any portion thereof, such as, for example, recognition of a biometric. As used herein, a biometric may include a user's voice, fingerprint, facial, ear, signature, vascular patterns, DNA sampling, hand geometry, sound, olfactory, keystroke/typing, iris, retinal or any other biometric relating to recognition based upon any body part, function, system, attribute and/or other characteristic, or any portion thereof.

The system may include or interface with any of the foregoing accounts or devices, a transponder and reader in RF communication with the transponder (which may include a fob), or communications between an initiator and a target enabled by near field communications (NFC). Typical devices may include, for example, a key ring, tag, card, cell phone, wristwatch or any such form capable of being presented for interrogation. Moreover, the system, computing unit or device discussed herein may include a “pervasive computing device,” which may include a traditionally non-computerized device that is embedded with a computing unit. Examples may include watches, Internet enabled kitchen appliances, restaurant tables embedded with RF readers, wallets or purses with imbedded transponders, etc. Furthermore, a device or financial transaction instrument may have electronic and communications functionality enabled, for example, by: a network of electronic circuitry that is printed or otherwise incorporated onto or within the transaction instrument (and typically referred to as a “smart card”); a fob having a transponder and an RFID reader; and/or near field communication (NFC) technologies. For more information regarding NFC, refer to the following specifications all of which are incorporated by reference herein: ISO/IEC 18092/ECMA-340, Near Field Communication Interface and Protocol-1 (NFCIP-1); ISO/IEC 21481/ECMA-352, Near Field Communication Interface and Protocol-2 (NFCIP-2); and EMV 4.2 available at http://www.emvco.com/default.aspx.

The account number may be distributed and stored in any form of plastic, electronic, magnetic, radio frequency, wireless, audio and/or optical device capable of transmitting or downloading data from itself to a second device. A consumer account number may be, for example, a sixteen-digit account number, although each credit provider has its own numbering system, such as the fifteen-digit numbering system used by American Express. Each company's account numbers comply with that company's standardized format such that the company using a fifteen-digit format will generally use three-spaced sets of numbers, as represented by the number “0000 000000 00000”. The first five to seven digits are reserved for processing purposes and identify the issuing bank, account type, etc. In this example, the last (fifteenth) digit is used as a sum check for the fifteen digit number. The intermediary eight-to-eleven digits are used to uniquely identify the consumer. A merchant account number may be, for example, any number or alpha-numeric characters that identify a particular merchant for purposes of account acceptance, account reconciliation, reporting, or the like.

Phrases and terms similar to “financial institution” or “transaction account issuer” may include any entity that offers transaction account services. Although often referred to as a “financial institution,” the financial institution may represent any type of bank, lender or other type of account issuing institution, such as credit card companies, card sponsoring companies, or third party issuers under contract with financial institutions. It is further noted that other participants may be involved in some phases of the transaction, such as an intermediary settlement institution.

Phrases and terms similar to “business” or “merchant” may be used interchangeably with each other and shall mean any person, entity, distributor system, software and/or hardware that is a provider, broker and/or any other entity in the distribution chain of goods or services. For example, a merchant may be a grocery store, a retail store, a travel agency, a service provider, an on-line merchant or the like.

The terms “payment vehicle,” “financial transaction instrument,” “transaction instrument” and/or the plural form of these terms may be used interchangeably throughout to refer to a financial instrument.

Phrases and terms similar to “merchant,” “supplier” or “seller” may include any entity that receives payment or other consideration. For example, a supplier may request payment for goods sold to a buyer who holds an account with a transaction account issuer.

Phrases and terms similar to a “buyer” may include any entity that receives goods or services in exchange for consideration (e.g. financial payment). For example, a buyer may purchase, lease, rent, barter or otherwise obtain goods from a supplier and pay the supplier using a transaction account.

Phrases and terms similar to “internal data” may include any data a credit issuer possesses or acquires pertaining to a particular consumer. Internal data may be gathered before, during, or after a relationship between the credit issuer and the transaction account holder (e.g., the consumer or buyer). Such data may include consumer demographic data. Consumer demographic data includes any data pertaining to a consumer. Consumer demographic data may include consumer name, address, telephone number, email address, employer and social security number. Consumer transactional data is any data pertaining to the particular transactions in which a consumer engages during any given time period. Consumer transactional data may include, for example, transaction amount, transaction time, transaction vendor/merchant, and transaction vendor/merchant location. Transaction vendor/merchant location may contain a high degree of specificity to a vendor/merchant. For example, transaction vendor/merchant location may include a particular gasoline filing station in a particular postal code located at a particular cross section or address. Also, for example, transaction vendor/merchant location may include a particular web address, such as a Uniform Resource Locator (“URL”), an email address and/or an Internet Protocol (“IP”) address for a vendor/merchant. Transaction vendor/merchant, and transaction vendor/merchant location may be associated with a particular consumer and further associated with sets of consumers. Consumer payment data includes any data pertaining to a consumer's history of paying debt obligations. Consumer payment data may include consumer payment dates, payment amounts, balance amount, and credit limit. Internal data may further comprise records of consumer service calls, complaints, requests for credit line increases, questions, and comments. A record of a consumer service call includes, for example, date of call, reason for call, and any transcript or summary of the actual call.

Phrases similar to a “payment processor” may include a company (e.g., a third party) appointed (e.g., by a merchant) to handle transactions for merchant banks. Payment processors may be broken down into two types: front-end and back-end. Front-end payment processors have connections to various transaction accounts and supply authorization and settlement services to the merchant banks' merchants. Back-end payment processors accept settlements from front-end payment processors and, via The Federal Reserve Bank, move money from an issuing bank to the merchant bank. In an operation that will usually take a few seconds, the payment processor will both check the details received by forwarding the details to the respective account's issuing bank or card association for verification, and may carry out a series of anti-fraud measures against the transaction. Additional parameters, including the account's country of issue and its previous payment history, may be used to gauge the probability of the transaction being approved. In response to the payment processor receiving confirmation that the transaction account details have been verified, the information may be relayed back to the merchant, who will then complete the payment transaction. In response to the verification being denied, the payment processor relays the information to the merchant, who may then decline the transaction. Phrases similar to a “payment gateway” or “gateway” may include an application service provider service that authorizes payments for e-businesses, online retailers, and/or traditional brick and mortar merchants. The gateway may be the equivalent of a physical point of sale terminal located in most retail outlets. A payment gateway may protect transaction account details by encrypting sensitive information, such as transaction account numbers, to ensure that information passes securely between the customer and the merchant and also between merchant and payment processor.

Phrases similar to “vendor software” or “vendor” may include software, hardware and/or a solution provided from an external vendor (e.g., not part of the merchant) to provide value in the payment process (e.g., risk assessment).

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” should be construed to exclude only those types of transitory computer-readable media which were found in In Re Nuijten to fall outside the scope of patentable subject matter under 35 U.S.C. §101.

1. A method comprising:
receiving, by a computer-based system for providing electronic help, a search query;
searching, by a search library running on the computer-based system and in response to the search query, a document object model (“DOM”) structure associated with a webpage displayed by the computer-based system;
identifying, by the computer-based system, a portion of the webpage based upon the searching;
shifting, by the computer-based system, focus to the identified portion of the webpage; and
modifying, by the computer-based system, the DOM associated with the webpage to cause the identified portion of the webpage to be visually identified within the webpage.

2. The method of claim 1, further comprising:
receiving, by the computer-based system, a selection of an option to receive electronic help;
communicating, by the computer-based system, with a help database to retrieve help data; and
displaying, by the computer-based system, a storyboard associated with the help data.

3. The method of claim 2, further comprising displaying, by the search library running on the computer-based system, the storyboard in a pertinent portion of a webpage based upon the DOM structure of the webpage.

4. The method of claim 1, further comprising communicating, by the computer-based system, with a help database to retrieve help data based upon the search query.

5. The method of claim 1, further comprising communicating, by the computer-based system, with a help database to install the search library in response to a request for help.

6. (canceled)

7. The method of claim 1, further comprising receiving, by the computer-based system, feedback.

8. A system comprising:
a processor for providing electronic help;
a tangible, non-transitory memory communicating with the processor;
the tangible, non-transitory memory having instructions stored thereon that, in response to execution by the processor, cause the processor to perform operations comprising:
receiving, by the processor, a search query;
searching, by a search library associated with the processor and in response to the search query, a document object model (“DOM”) structure associated with a webpage displayed by the processor;
identifying, by the processor, a portion of the webpage based upon the searching;
shifting, by the processor, focus to the identified portion of the webpage; and
modifying, by the processor, the DOM associated with the webpage to cause the identified portion of the webpage to be visually identified within the webpage.

9. The system of claim 8, further comprising:
receiving, by the processor, a selection of an option to receive electronic help;
communicating, by the processor, with a help database to retrieve help data; and
displaying, by the processor, a storyboard associated with the help data.

10. The system of claim 9, further comprising displaying, by the search library running on the processor, the storyboard in a pertinent portion of a webpage based upon the DOM structure of the webpage.

11. The system of claim 8, further comprising communicating, by the processor, with a help database to retrieve help data based upon the search query.

12. The system of claim 8, further comprising communicating, by the processor, with a help database to install the search library in response to a request for help.

13. (canceled)

14. The system of claim 8, further comprising receiving, by the processor, feedback.

15. An article of manufacture including a non-transitory, tangible computer readable storage medium having instructions stored thereon that, in response to execution by a computer-based system for providing electronic help, cause the computer-based system to perform operations comprising:
receiving, by the computer-based system, a search query;
searching, by a search library running on the computer-based system and in response to the search query, a document object model (“DOM”) structure associated with a webpage displayed by the computer-based system;
identifying, by the computer-based system, a portion of the webpage based upon the searching;
shifting, by the computer-based system, focus to the identified portion of the webpage; and
modifying, by the computer-based system, the DOM associated with the webpage to cause the identified portion of the webpage to be visually identified within the webpage.

16. The article of claim 15, further comprising:
receiving, by the computer-based system, a selection of an option to receive electronic help;
communicating, by the computer-based system, with a help database to retrieve help data; and
displaying, by the computer-based system, a storyboard associated with the help data.

17. The article of claim 16, further comprising displaying, by the search library running on the computer-based system, the storyboard in a pertinent portion of a webpage based upon the DOM structure of the webpage.

18. The article of claim 15, further comprising communicating, by the computer-based system, with a help database to retrieve help data based upon the search query.

19. The article of claim 15, further comprising communicating, by the computer-based system, with a help database to install the search library in response to a request for help.

20. (canceled)
